(19) United States
(12) Patent Application Publication
(10) Pub. No.: US 2019/0176505 A1
(43) Pub. Date: Jun. 13, 2019

(54) DEVICE FOR DOUBLE FOLDING LEAVES

(71) Applicant: PELEMAN INDUSTRIES, NAAMLOZE VENNOOTSCHAP, Puurs (BE)

(72) Inventors: Maarten Luc C. HENNISSEN, Puurs (BE); Bruno Nicole J. VAN DE WALLE, BELSELE (BE)

(73) Assignee: PELEMAN INDUSTRIES, NAAMLOZE VENNOOTSCHAP, Puurs (BE)

(21) Appl. No.: 16/310,626

(22) PCT Filed: Jun. 21, 2017
(86) PCT No.: PCT/BE2017/000031

§ 371 Date: Dec. 17, 2018

(30) Foreign Application Priority Data
Jun. 29, 2016 (BE) 2016/5501

(51) Int. Cl. B42C 5/00

(52) U.S. Cl. CPC B42C 5/00

(57) ABSTRACT

In a device for double folding leaves, the device is provided with two conveyor belts that are located against one another such that leaves can be clasped between the conveyor belts with the exception of a strip that protrudes between the conveyor belts, whereby the conveyor belts are aligned with respect to one another along the side of the strip and with two or more folding elements along the conveyor belts that can fold the aforementioned strip, whereby the device. is equipped such that leaves are guided with their strip alongside the folding elements by the driving of the conveyor belts, whereby at least one folding element folds the strip in one direction and at least one folding element folds the strip in the other direction.

The present invention relates to a device for double folding leaves.

More specifically, the invention is intended for realising leaves where a strip of the leaves has been double folded along the same line, whereby these leaves are for a book or file whose leaves can be opened flat. In addition, any printing can continue seamlessly across the two opened leaves. This is particularly desirable for compiling books of photographs, magazines and similar with photographs and illustrations that continue across the entire width of the opened book.

Double folding here means that the strip is first folded in the one direction and then in the other direction.

The thus created fold line will enable the leaves to be folded open along this fold line, and when the bundle of leaves is bound in a spine, the leaves lie with their sharp fold lines against one another and flat so that the folded leaves are nicely flat and can be easily read, and moreover the printing continues seamlessly across the opened leaves as it were.

Instead of binding the bundle in a spine, the bundle can also be bound using PUR adhesive in a quick-bind file or in another manner.

Moreover, there is no gap between the opened leaves when the bundle is open, such that the adhesive or stitching or staples that are used for binding the bundle in the spine are net visible and thus also do net interfere with the printing that continues from the one leaf to the other leaf.

Devices are already known for double folding leaves, as described in the international patent application WO 2014/072778, whereby a leaf of paper is clasped between two plates with a protruding strip of approximately 15 millimetres for example.

This strip is folded downwards and upwards with a V-shaped element. Hereby the paper will be static with respect to the device, consequently a lot of time is lost by inserting, positioning and removing the leaves of paper.

Practice has shown that it is difficult to realise the double folding of the leaves in less than three seconds, which means approximately 1,200 leaves per hour.

Such limited numbers require very many machines to obtain an acceptable production quantity.

The purpose of the present invention is to provide a solution to at least one of the aforementioned and other disadvantages.

The object of the present invention is a device for double folding leaves, whereby the device is provided with two conveyor belts that are located against one another such that leaves can be clasped between the conveyor belts with the exception of a strip that protrudes between the conveyor belts, whereby the conveyor belts are aligned with respect to one another along the side of the strip and with two or more folding elements along the conveyor belts that can fold the aforementioned strip, whereby the device is equipped such that leaves are guided with their strip alongside the folding elements by the driving of the conveyor belts, whereby at least one folding element, folds the strip in one direction and at least one folding element folds the strip in the other direction.

‘Against one another’ here means ‘functionally against one another’ or ‘practically against one another’. This means that the conveyor belts are placed close to one another such that a leaf, that is between the conveyor belts, is clasped and is carried along when the conveyor belts are driven. A requirement for this is that there is sufficient friction or clasping force. Such a requirement is easy to realise for a person skilled in the art by trial and error (experimental determination).

‘The conveyor belts are aligned with respect to one another along the side of the strip’ means that they run perfectly equally so that the fold upwards and the fold downwards will be formed on exactly the same fold line.

An advantage is that the leaves can be guided through the folding elements at a high speed by means of the conveyor belts.

For the double folding of the strip of the leaves no successive operations are required such as the insertion, positioning and removal leaf by leaf. The leaves can pass successively alongside the folding elements and are, double folded during their passage to the folding elements.

Such a dynamic way of proceeding will substantially increase the production speed.

The folding elements can be constructed in many different ways. Preferably they are passive elements, i.e. there are no moving parts, but that use is made of the movement of the leaf along the folding elements to make the fold.

Preferably at least one folding element is a ‘pre-folder’, whereby this pre-folder folds the aforementioned strip over an angle of 90° or approximately 90°.

Approximately 90° here means that the angle is between 45° and 100°, but preferably between 85° and 95°.

Preferably, at least one folding element is a folder, whereby this folder folds the aforementioned strip over an angle greater than 110°, and preferably over an angle greater than 125°.

It is not excluded that this angle is 135° or this angle approaches 180°.

The use of such a pre-folder will condition or prepare the leaf to then be able to create the actual sharp fold with the folder. Due to the creation of the fold line in two steps, a well defined fold line will be obtained and will be able to prevent the strip from being unintentionally folded or bent at an undesired location during the folding process. This will be especially important with thicker leaves.

Preferably an unfolding element is placed after a folding element, whereby this unfolding element can unfold the folded strip back to the plane of the page.

This has the advantage that the strip is again favourably placed for folding by a subsequent folding element, that will (possibly) fold the strip of the leaf in the other direction.

With the intention of better showing the characteristics of the invention, a few preferred embodiments of a device for double folding leaves according to the invention are described hereinafter, by way of an example without any limiting nature, with reference to the accompanying drawings, wherein:

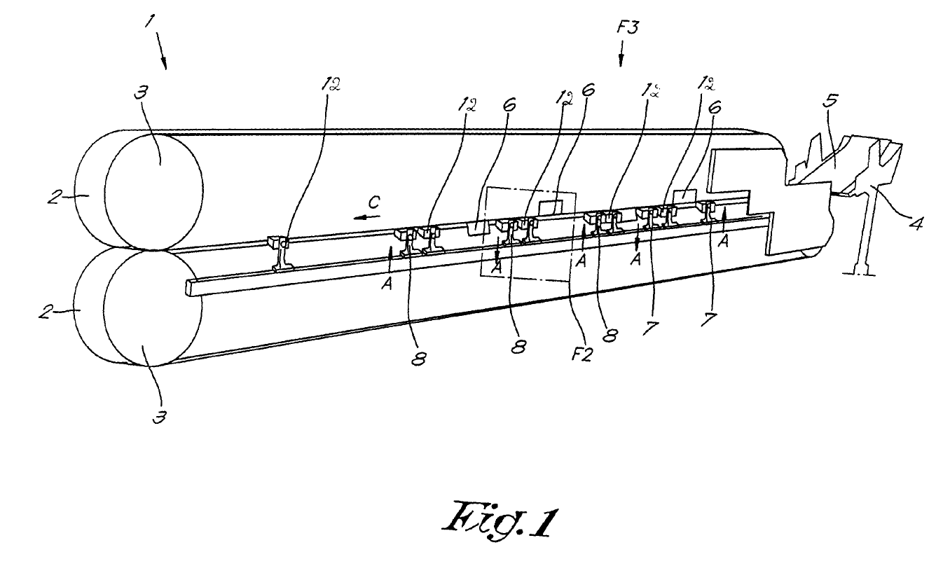

FIG. 1 schematically shows a perspective view of a device for double folding leaves according to the invention;

FIG. 2 schematically shows a perspective view of the

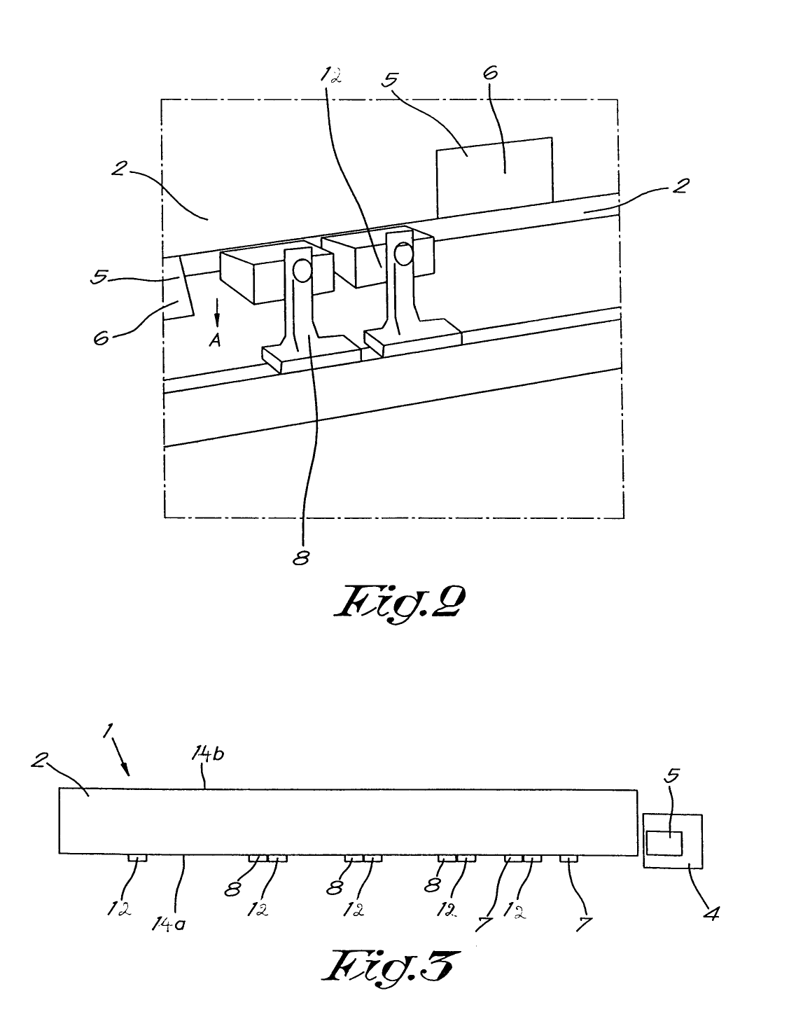

FIG. 3 schematically shows a top view of the device of FIG. 1 with a possible order of the successive folding elements;

FIGS. 4 to 9 show different embodiments of folding elements and an unfolding element.

The device 1 shown in FIG. 1 essentially comprises two conveyor belts 2 that are located against one another.

The conveyor belts 2 are of the ‘endless’ type, which means that they are looped and as it were are affixed around two reversing drums 3 or reversing wheels.

The conveyor belts 2 are made of metal, such as steel for example.

Preferably the conveyor belts 2 are a maximum of 0.4 millimetres thick, preferably a maximum of 0.2 millimetres thick. In this case they are 0.2 millimetres thick.

The device 1 is also provided with a supply 4 for introducing leaves 5 between the conveyor belts 2. These leaves 5 can be paper leaves 5, but also leaves 5 of (thin) cardboard, plastic or similar.

The leaves 5 may or may not be provided with printing, for example text, photographs, drawings and similar.

Because the conveyor belts 2 are located against one another, leaves 5 can be clasped between the conveyor belts 2 except for a strip 6 that protrudes between the conveyor belts 2.

This is shown in the detail of FIG. 2.

The protruding strip 6 preferably has a width of between 10 and 20 millimetres. In this case the strip 6 is 15 millimetres wide.

As already stated, the conveyor belts 2 are only 0.2 millimetres thick. However, it is not necessary that the entire conveyor belts 2 are so thin. Only (at least) the side 14a of the conveyor belts 2 has to be as thin as possible along the side of the strip 6 to obtain a sharp fold. The conveyor belts 2 themselves may be thicker.

In this case the conveyor belts 2 are driven or moved synchronously, for example by driving the reversing drums 3.

According to the invention, the conveyor belts are aligned along the side of the strip 6 with respect to one another, which means that they run exactly the same so that the fold upwards and the fold downwards will be formed along exactly the same fold line.

A number of folding elements 7, 8 are placed along the conveyor belts 2. In this case there are five folding elements 7, 8.

In this case it concerns two pre-folders 7 and three folders 8. As can clearly be seen in FIGS. 1 and 3, the pre-folders, which in this case fold the strip 6 over an angle of only 90°, are placed before the folders 8, which in this case fold the strip over an angle of 135°. As already stated above, the pre-folders 7 will condition or prepare the leaf 5 as it were before the folders 8 fold the strip 6 over a larger angle.

The arrows A indicate the direction in which the pre-folders 7 and folders 8 will fold the strip 6 of a leaf 5.

In this case the following folding elements 7, 8 are placed successively:
a first pre-folder 7 that folds the strip 6 in the one direction;
8 second pre-folder 1 that folds the strip 6 in the other direction;
a first folder 8 that folds the strip 6 in the one direction;
a second folder 8 that folds the strip 6 in the other direction.

In this case a third folder 8 is placed after the second folder 8 that will again fold the strip 6 in the one direction.

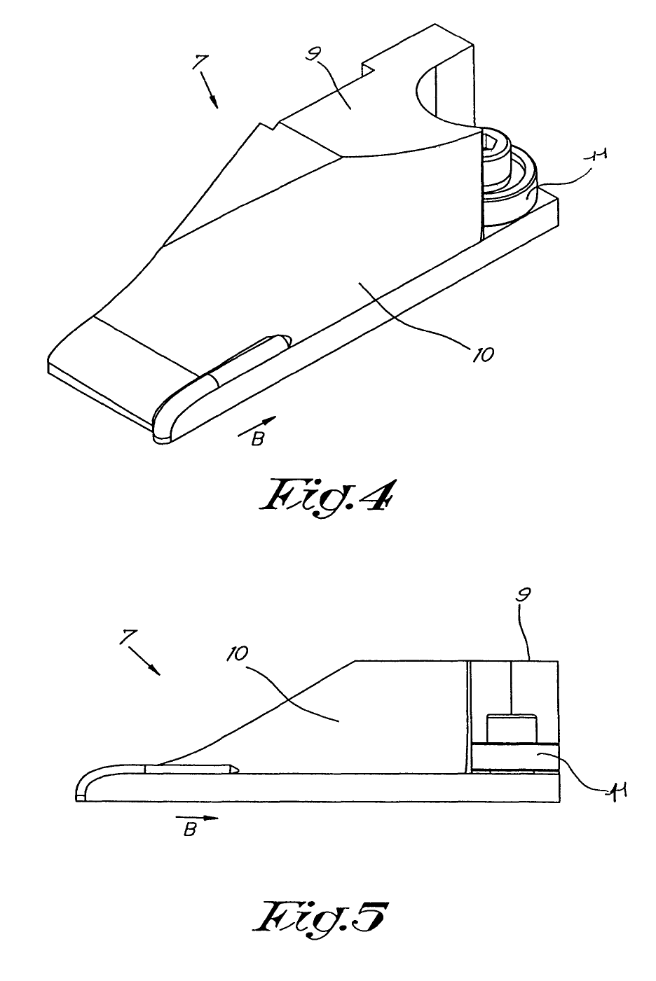

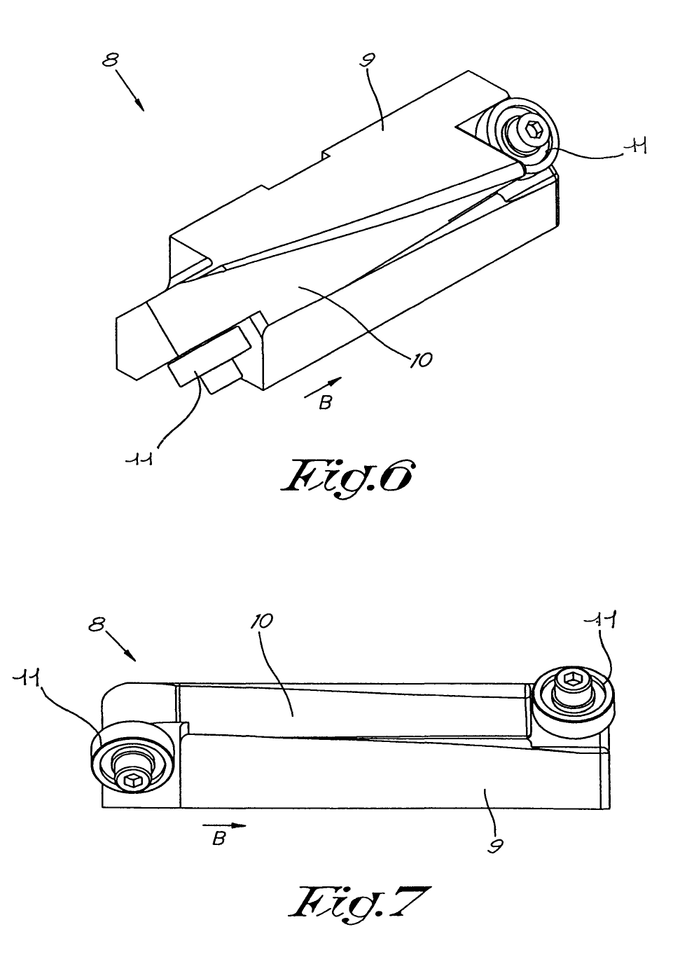

FIGS. 4 to 7 show a possible design of the folding elements 7, 8. FIGS. 4 and 5 show a possible design of a pre-folder 7, while FIGS. 6 and 7 show a possible design of a folder 8.

The folding elements 7, 8 are generally constructed as profiled elements 9 that are provided with a contact surface 10 or end stop for the strip 6, whereby this contact surface 10 or end stop, viewed along the longitudinal direction of the folding element 7, 8, tilts to be able to fold the strip 6.

The angle at which the contact surface 10 tilts is 90° for the pre-folder 7 of FIGS. 4 and 5, and 135° for the folder 8 of FIGS. 6 and 7.

The aforementioned longitudinal direction of the folding element 7, 8 is the direction in which the strip 6 will move along the folding element 7, 8, and is indicated by the arrow B in the drawings concerned.

In this case, but not necessarily for the invention, the folding elements 7, 8 are provided with pressing means to push the strip 6 on the edge of the conveyor belt 2, whereby these pressing means take on the form of a ball bearing 11.

This ball bearing 11 is placed such that its outer ring can push on the strip 6.

In this case the folders 8 are each provided with two such ball bearings 11.

In this case, but not necessarily, the device 1 is also provided with unfolding elements 12. In this case, an unfolding element 12 is placed alter each folding element 7, 8 so that the device 1 has five unfolding elements 12 in total.

It is also possible that an unfolding element 12 is only placed after the three folders 8.

The unfolding element 12 will unfold the folded strip 6 back to the plane of the leaf 5, after it has been folded by a folding element 7, 8.

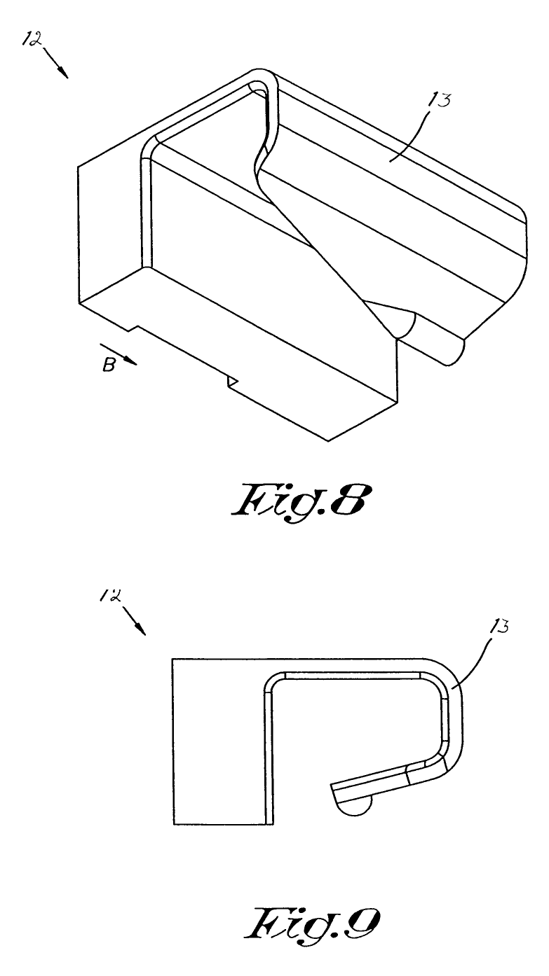

FIGS. 8 and 9 show a possible design of such an unfolding element 12.

As can be seen in this drawing, the unfolding element 12 comprises a hook-shaped part 13 that will grip behind the folded strip 6 and which by its design will fold open the strip 6 when the leaf 5 passes along the unfolding element 12.

The operation of the device 1 is simple and as follows.

By means of the supply 4 the leaves 5 will be introduced between the conveyor belts 2 one by one. As a result it will be ensured that a strip 6 of the leaves 5 protrudes between the conveyor belts 2.

As already mentioned, the conveyor belts 2 are driven synchronously, and this can be realised in different ways.

In this case the reversing drums 3 are driven by an electric motor, but a hydraulic or pneumatic drive is also possible.

The device 1 is such that the leaves 5 are guided in the direction of arrow C by the drive of the conveyor belts 2, with their strip 6 along the folding elements 7, 8 and the unfolding elements 12.

When the strip 6 moves along the first pre-folder 7 it is folded in the direction of the arrow A.

When the strip 6 passes along the ball bearing 11 of the pre-folder 7, the outer ring of the ball bearing 11 will push the strip 6 against the edge of the conveyor belt, in this case at an angle of 90°.

The subsequent unfolding element 12 will unfold the strip 6 back to the plane of the leaf 5.

Then the same is repeated when the strip 6 passes along the second pre-folder 7 and unfolding element 12, but in the other direction.

Then the strip 6 of the leaf 5 passes along the first of three folders 8 in order to fold the strip 6 in the direction of arrow A over an angle of 135°.

When the strip 6 passes along the second ball bearing 11 of the folder 8, the outer ring of this ball bearing 11 will push the strip 6 against the edge of the conveyor belt 2, in this case at an angle of 135°.

Then the leaf 5 will pass to the third unfolding element 12 in order to fold the strip 6 back to the plane of the leaf 5, before the strip 6 is folded by the second and third folder 8, in the directions according to the arrows A concerned, as indicated in FIGS. 1 and 2.

Because the conveyor belts 2 are very thin, or at least on the side 14a along the side of the strip 6, and because the conveyor belts 2 run perfectly equally along the side of the strip 6, a sharp fold line can be obtained and the strip 6 will be double folded along exactly the same line. Hence it is important that the conveyor belts 2 are preferably a maximum of 0.2 millimetres thick.

When the leaf 5 has come to the end of the conveyor belts 5, the strip 6 will be double folded in both directions and in this case one time extra in the one direction.

The leaf 5 can then be used in a book or file whereby the leaves 5 can be opened flat and the printing can continue seamlessly over the two opened leaves 5.

Although in the example shown, folding elements 7, 8 are only deployed on one side 14 of the conveyor belts 2, as can clearly be seen in FIG. 3, it is not excluded that folding elements 7, 8 are located along the conveyor belts 2 on either side 14a, 14b of the conveyor belts 2, whereby leaves 5 are clasped between the conveyor belts 2 by their protruding atrip 6 along the one side 14a and by their protruding strip 6 along the other side 14b of the conveyor belts 2.

In other words the strip 6 of a leaf 5 will either be located on the one side 14a or on the other side 14b of the conveyor belt 2.

If the conveyor belts 2 are wide enough/ the leaves 5 can be introduced into the device 1 by twos next to one another. If this is not the case, the leaves 5 can protrude alternately with their strip 6 on the one side 14a or on the other side 14b of the conveyor belts 2.

It is clear that in the embodiments described above, the length of the conveyor belts 2 is chosen such that the necessary numbers of folding element 7, 8 can be placed along the conveyor belts 2.

If for example the leaves 5 are made of thicker or tougher material, it may be that a number of additional folders 8 must be placed in the embodiment of FIG. 1. The conveyor belts 2 are then made longer, so that the extra folders 8 can be placed after the last unfolding element 12.

Although in the examples described above the device 1 is provided with two conveyor belts 2, it is not excluded that the device 1 is provided with more than two conveyor belts 2 that are located against one another.

As a result, in each case leaves 5 can be clasped between two conveyor belts 2 located next to one another by a strip 6 that protrudes between the conveyor belts 2, for example between the first and the second and between the second and the third conveyor belt 3.

Hereby the first and the second conveyor belt 2 will move the leaves 5 forward in the one direction C and the second and third conveyor belt 2 will move the leaves 5 in the opposite direction opposite to the direction C.

Of course in this case the device 1 will be provided with two series of folding elements 7, 8, one series at the level of the leaves 5 between the first and second conveyor belt 2 and one series at the level of the leaves 5 between the second and third conveyor belt 2.

With more than three conveyor belts 2, the number of series of folding elements 7, 8 are increased similarly.

The series of folding elements 7, 8 can be the same but can also be different, both with regard to the number and with regard to type of folding elements 7, 8 (pre-folder 7, folder 8).

Although in the embodiments described above the folding elements 7, 8 are static with respect to the device 1 and the leaves 5 move with respect to the device 1, it is not excluded that the folding elements 7, 8 move with respect to the device 1, while the leaves are static with respect to the device 1 during the double folding of the strip 6.

In this way the device 1 can for example be integrated in a printer or similar, whereby after printing the leaf 5 the strip 6 is double folded.

The device 1 will then be provided with clasping means to be able to clasp a leaf 5 by a protruding strip 6 and two or more folding elements 7, 8 that can move along the aforementioned strip 6 to be able to fold it, whereby at least one folding element 7, 8 folds the strip 6 in one direction and at least one folding element 7, 8 folds the strip 6 in the other direction.

Preferably the folding elements 7, 8 make a rotating or cyclic movement according to a flattened looped path, whereby the folding elements 7, 8 pass along the strip 6 in the flattened parts of the path.

All previously said properties relating to the folding elements 7, 8 also apply to this embodiment, as well as the unfolding elements 12.

The present invention is by no means limited to the embodiments described as an example and shown in the drawings, but a device for the double folding of leaves according to the invention can be realised in all kinds of forms and dimensions without departing from the scope of the invention.

1. Device for double folding leaves, wherein the device U) is provided with two conveyor belts (2) that are located against one another such that leaves (5) can be clasped between the conveyor belts (2) with the exception of a strip (6) that protrudes between the conveyor belts (2), whereby the conveyor belts (2) are aligned with respect to one another along the side of the strip (6) and with two or more folding elements (7, 8) along the conveyor belts (2) that can fold the aforementioned strip (6), whereby the device (1) is equipped such that leaves (5) are guided with their strip (6) alongside the folding elements (7, 8) by the driving of the conveyor belts (2), whereby at least one folding element (7, 8) folds the strip (6) in one direction and at least one folding element (7, 8) folds the strip (6) in the other direction.

2. Device according to claim 1, wherein at least one folding element (7, 8) is a pre-folder (7) that folds the aforementioned strip (6) over an angle of 90°.

3. Device according to claim 2, wherein at least one folding element (7, 8) is a folder (8) that folds the aforementioned strip (6) over an angle greater than 110°.

4. Device according to claim 3, wherein one or more pre-folders (7) are placed before the one or more folders (8).

5. Device according to claim 1, wherein the following folding elements (7, 8) are placed along the conveyor belt (2) successively:
a first pre-folder (7) that folds the strip (6) in the one direction;
a second pre-folder (7) that folds the strip (6) in the other direction;
a first folder (8) that folds the strip (6) in the one direction;
a second folder (8) that folds the strip (6) in the other direction.

6. Device according to claim 1, wherein an unfolding element {12) is placed after a folding element (7, 8) whereby this unfolding element (12) can unfold the folded strip (6) back to the plane of the leaf (5).

7. Device according to claim 1, characteris wherein the folding elements (7, 8) are constructed as profiled elements (9) that are provided with a contact surface (10) or end stop for the strip, whereby this contact surface (10) or end stop tilts, viewed along the longitudinal direction of the folding element (7, 8), to be able to fold the strip (6).

8. Device according to claim 8, wherein the folding elements (7, 8) are provided with pushing means to push the strip (6) on the edge of the conveyor belt (2).

9. Device according to claim 1, wherein the conveyor belts (2) are made of metal and that at least the side (14a) of the conveyor belts (2) along the side of the strip (6) is a maximum of 0.4 millimetres.

10. Device according to claim 1, character wherein the device (1) is provided with a supply (4) to introduce leaves (5) between the conveyor belts (1).

11. Device according to claim 1, wherein the protruding strip {6} has a width between 10 and 20 millimetres.

12. Device according to claim 1, wherein folding elements (7, 8) are located along the conveyor belts (2) on either side (14a, 14b) of the conveyor belts (2), whereby leaves (5) are clasped between the conveyor belts (2) by their protruding strip (6) along the one side (14a) and by their protruding strip (6) along the other side (14b).

13. Device according to claim 1, wherein the conveyor belts (2) are driven or moved synchronously.

14. Device according to claim 1, wherein the device (1) is provided with more than two conveyor belts (2) that are located against one another such that leaves (5) can be clasped between two conveyor belts (2) located against one another.

15. Device according to claim 1, wherein the length of the conveyor belts (2) is chosen such that the necessary numbers of folding elements (7, 8) can be placed along the conveyor belts (2).

16. Device for double folding leaves, wherein the device (1) is provided with clasping means to be able to clasp a leaf (5) by a protruding strip (6) and with two or more folding elements (7, 8) that can move along the aforementioned strip (6) in order to be able to fold them, whereby at least one folding element (7, 8) folds the strip in one direction and at least one folding element (7, 8) folds the strip in the other direction.

17. Device according to claim 16, wherein the folding elements (7, 8) make a rotating or cyclic movement according to a flattened looped path, whereby the folding elements (7, 8) pass along the strip (6) on the flattened parts of the path.

18. Device according to claim 3, wherein the folder folds the strip over an angle greater than 125°.

19. The device of claim 9 wherein the at least the side (14a) of the conveyor belts (2) along the side of the strip (6) is a maximum of 0.2 millimetres.

20. The device of claim 11, wherein the protruding strip has a width of 15 millimetres.
